(19) United States
(12) Patent Application Publication
(10) Pub. No.: US 2017/0036857 A1
(43) Pub. Date: Feb. 9, 2017

(54) SINGLE SERVE CAPSULE AND METHOD FOR PREPARING A BEVERAGE USING A SINGLE SERVE CAPSULE

(71) Applicant: K-FEE SYSTEM GMBH, Bergisch Gladbach (DE)

(72) Inventors: Günter Empl, Bergisch Gladbach (DE); Marc Krüger, Bergisch Gladbach (DE)

(21) Appl. No.: 15/303,859

(22) PCT Filed: Apr. 16, 2015
(86) PCT No.: PCT/EP2015/058289

§ 371 Date: Oct. 13, 2016

(30) Foreign Application Priority Data
Apr. 17, 2014 (DE) 10 2014 105 486.5

(51) Int. Cl. B65D 85/804; B29C 65/08

(52) U.S. Cl. CPC B65D 85/8043; B29C 65/08; B29K 2067/00

(57) ABSTRACT

Disclosed is a single-serve capsule for preparing a beverage, comprising a capsule member that includes a capsule bottom and a filling end, a cavity being formed between the capsule bottom and the filling end for holding a powdery or liquid beverage substrate. A filter element is placed between the beverage substrate and the capsule bottom, said filter element comprising a nonwoven fabric which is placed in the region of the capsule bottom.

The present invention relates to a portion capsule for producing a beverage, having a capsule body with a capsule base and a filling side, with a cavity for accommodating a pulverulent or liquid beverage base being formed between the capsule base and the filling side, and with a filter element being arranged between the beverage base and the capsule base.

Portion capsules of this kind are generally known from the prior art. By way of example, documents EP 1792850 B1, BP 1344722 A1 and US 2003/0172813 A1 disclose portion capsules of this generic type for preparing coffee and espresso.

Portion capsules of this kind for producing a beverage are preferably in the form of a truncated cone or cylinder and are produced, for example, from a thermoformed plastic film or using a plastic injection molding process. Said portion capsules usually have an open filling side with a collar edge onto which a cover film or foil is sealed or adhesively bonded, a closed capsule base, with a particle screen which is supported against the capsule base being arranged between the beverage base and the capsule base. These screens are either injection molded from a thermoplastic or are thermoformed or stamped from a plastic film.

For the purpose of preparing a coffee beverage, the portion capsule is inserted into a brewing chamber of a preparation appliance. After or during the closing process of the brewing chamber, the capsule is preferably opened on its closed base side by means of an opening mandrel which is arranged in the brewing chamber and, after the brewing chamber is sealed off, the filling side of the portion capsule, which filling side is sealed off by a sealing film or foil, is tapped by means of a puncturing means. Preparation liquid, preferably hot water, is then delivered into the portion capsule under pressure. The preparation liquid flows through the beverage base and extracts and/or dissolves the substances, which are required for producing the beverage, from the beverage base. For the purpose of preparing an espresso, for example a brewing water pressure of up to 20 bar acts on the coffee powder for the purpose of extracting the essential oils. This pressure also acts on the particle screen which is situated between the coffee powder and the capsule base and in front of the punctured capsule outlet.

A disadvantage of the screens which are produced using a plastic injection molding process or using a thermoforming or stamping process is, however, that the openings in the screen holes have to be smaller than the smallest coffee particles in order to retain the coffee particles. Since a certain proportion of dust is necessarily produced in a coffee grinding process, coffee particles pass through if the screen holes are too big or the screens are blocked if the screen holes are too small, in particular at high pressures. Furthermore, corresponding supporting elements which act against the capsule base are required beneath the screens in order to absorb the brewing water pressures of up to 20 bar and to prevent deformation of the screens as a result of the high brewing water pressure (together with a high brewing water temperature). These supporting elements disadvantageously require additional material to be used, particularly in the case of screen arrangements produced using an injection molding process, as a result of which the production costs rise.

Therefore, the prior art discloses portion capsules with screen arrangements which are intended to avoid these disadvantages. U.S. Pat. No. 2,778,739, EP 1710173 A1 and U.S. Pat. No. 5,352,765 disclose portion capsules having screen arrangements which consist of a screen support with relatively large passage openings, with these openings being covered by a filter material. A disadvantage of these arrangements is that additional costs for material and manufacture are incurred for forming such screen arrangements since they consist of a stable screen support and the filter material which is arranged on the screen support.

Both in the case of screens with screen holes and in the case of screen arrangements with an additional filter material, it is necessary to ensure that the ready beverage which passes through the screen arrangement can flow to a capsule outflow opening, that is to say a free space for the discharge of a beverage has to be provided between the capsule base and the screen arrangement. In addition, screen arrangements of this kind take up their own proportion of space in the portion capsule, this leading to an increase in the volume of the capsule and thus necessarily likewise to additional material being used.

The prior art, for example WO 2012/010317, furthermore discloses a filter which is known from a non-woven fiber material. However, this filter cannot be used for all coffee dispensers.

The object of the present invention was therefore to provide a portion capsule having a filter arrangement, which portion capsule is less expensive to manufacture in comparison to the prior art and in which the disadvantages described in connection with the prior art are avoided at the same time.

This object is achieved by a portion capsule for producing a beverage, having a capsule body with a capsule base and a filling side, with a cavity for accommodating a pulverulent or liquid beverage base being formed between the capsule base and the filling side and with a filter element being arranged between the beverage base and the capsule base, with the filter element being provided from a non-woven material which is arranged in the region of the capsule base, with the filter element being provided from two layers.

In comparison to the prior art, the portion capsule according to the invention has the advantage that a simple and cost-effective filter non-woven or felt is used as the filter screen. A complicated plastic injection molding process or a thermoforming or stamping process for producing the screens can therefore be saved. The production costs are therefore considerably lowered. In addition, a supporting structure is not required since the non-woven is supported directly on the capsule base. In addition, a filter non-woven has the advantage over the plastic filters known from the prior art that it has a considerably larger liquid inlet surface. Furthermore, transverse flow of liquid (parallel to the plane of main extent of the filter plane) is made possible, as a result of which improved mixing and outflow behavior is achieved. It has also been found that the risk of the screens becoming blocked is considerably reduced or virtually eliminated when a filter non-woven is used. Surprisingly, the filter non-woven has proven to be resistant to blockage both in the case of a beverage preparation with a preparation liquid which is under a comparatively low pressure and in the case of a beverage preparation with a preparation liquid which is under a comparatively high pressure. Furthermore, a transverse flow of liquid in the filter non-woven is always reliably maintained and outflow of the liquids entering the filter non-woven to an outflow opening is always reliably ensured. In spite of this, a so-called “crema”, that is to say foam, forms on the beverage, in particular the espresso. Since the filter element has two layers, one layer can be pierced by a perforation element without the majority of granules entering the beverage which is to be prepared.

The two layers are preferably initially separated and are connected to one another before and/or during the portion capsule production process, in particular when they are connected to the base of the portion capsule. The portion capsule within the meaning of the present invention comprises a preferably hermetically sealed portion capsule. This means that the beverage or food product powder, for example coffee powder, soup powder or tea, located in the portion capsule is sealed off from the environment in a substantially aroma-tight manner before the extraction process. However, the portion capsule does not have to be hermetically sealed, but rather can also be provided in a hermetically sealed package prior to use, said package then being opened, for example manually.

A non-woven within the meaning of the invention is an unordered, non-woven structure comprising fibers, in particular plastic fibers. A non-woven within the meaning of the invention can be produced from plastic and/or natural fibers. A non-woven can consist, for example, of paper or paper-like materials.

The two layers are preferably produced from a non-woven material. The two non-woven layers are preferably identical in respect of material, thickness and/or diameter. The two layers are preferably connected to one another, in particular by welding, preferably ultrasonic welding. The join is preferably made along a circular ring which is particularly preferably located in, or in the vicinity of, the edge region of the filter.

According to a preferred embodiment of the present invention, provision is made for the non-woven to comprise a non-woven material which is produced from fine plastic fibers, for example fine polyester fibers, and, in particular, is a random fiber non-woven and/or a fiber-oriented non-woven. The non-woven preferably has a mass per unit area (also called the grammage or the basis weight) of between 40 and 250 grams per square meter, particularly preferably of between 80 and 120 grams per square meter, and very particularly preferably of substantially 100 grams per square meter. One layer of the filter element preferably has a thickness of between 0.2 and 2.0 millimeters, particularly preferably of between 0.25 and 0.39 millimeters, and very particularly preferably of substantially 0.32 millimeters. The non-woven is formed in such a way that air permeability of the non-woven is preferably between 1000 and 3000 l/(m²s), particularly preferably between 1500 and 2500 l/(m²s), and very particularly preferably substantially 2000 l/(m²s) at a pressure of 100 pascal. It has surprisingly and unforeseeably been found that optimum results in terms of extraction efficiency, mixing and outflow behavior and also blockage resistance can be achieved with non-wovens of this kind and that the “crema” is formed in spite of this. Nevertheless, the beverage base is effectively retained even if the piercing mandrel taps and/or pierces the filter element.

The non-woven is preferably arranged on the base of the capsule such that it rests on as large a surface area as possible. The non-woven is particularly preferably sealed to the base, in particular by ultrasound. The non-woven is further preferably stretched before it is attached to the capsule, in particular to the capsule base, in order to improve the abutment against the base.

Preferably, the filter element covers the capsule base completely or only partially.

When the capsule is opened by a perforation means, it is advantageous if this perforation means moves the non-woven away from the capsule base and thus stretches or additionally stretches said non-woven. In this case, the perforation means can enter at least one layer of the non-woven and/or penetrate at least one layer of the non-woven.

According to a further embodiment of the present invention, the filter element has one non-woven layer and one layer with a felt structure. Said felt structure is, in particular, a needle felt structure. The filter layer preferably consists of at least one felt structure and a support structure, in particular a woven structure, with the felt structure, at least a subsection of the volume, particularly preferably comprising the support structure. The felt structure preferably extends over the entire cross section of the support structure. The felt structure is preferably connected to the support structure in an interlocking, force-fitting and/or cohesive manner.

The surface of the felt structure or of the non-woven is preferably treated, for example thermally treated, in order to fix, for example, loose fibers.

The layer which has the felt structure is preferably connected to the non-woven layer, in particular in a cohesive manner.

A filter element which has a support structure, in particular a woven structure, and a felt structure is produced, for example, by a woven structure comprising longitudinal and transverse threads being provided. In order to construct a felt, in particular a needle felt, fiber units of 0.8-7 dtex are preferably selected. The individual fibers are connected to one another to form a felt and/or are anchored in the support structure preferably by the needling production process. In this case, needles with inverse barbs are inserted into and pulled out of the prelaid fiber packet at high speed. On account of the inverse barbs, the fibers are interwoven with one another and/or with the support woven by means of a large number of loops which are produced.

The support structure having one or more felt structures preferably has a mass per unit area (also called the grammage or the basis weight) of between 100 and 1500 grams per square meter, particularly preferably of between 200 and 650 grams per square meter, and very particularly preferably of substantially 150-250 grams per square meter in particular for producing tea but also for coffee, espresso and the like, and 600-700 grams per square meter for producing coffee, espresso or the like but also for tea. Very particularly preferably, the grammage is 1000-1300 grams per square meter for producing coffee, espresso or the like but also for tea. The layer with the felt structure preferably has a thickness of between 0.4 and 5.0 millimeters, particularly preferably of between 1.1 and 3.0 millimeters, and very particularly preferably of 1.2-1.4 millimeters for producing tea and 2.6-3.0 for producing coffee.

The filter element is preferably inserted into the capsule body and is then connected to said capsule base and/or to the side wall of the capsule, in particular by welding, for example using ultrasound, before the capsule body is filled with the beverage base.

The capsule body is preferably in the form of a truncated cone or cylinder and is, for example, produced from plastic, a natural material and/or a biologically degradable material comprising a thermoformed plastic film or using a plastic injection molding process. The capsule body preferably has, on the filling side, a collar edge onto which a cover film or foil is sealed or adhesively bonded. As an alternative, it is feasible for the capsule body and a capsule cover to be connected to one another by means of a mechanical method. The base of the portion capsule is preferably closed and is preferably first perforated in the brewing chamber by means of a perforation means for producing an outflow opening, said perforation means acting on the portion capsule base from the outside. However, another feasible alternative would be for the base of the portion capsule to already be provided with an outlet opening at the factory, said outlet opening preferably being sealed off by means of a sealing film or foil. The sealing film or foil can be perforated, for example, by means of the perforation means or can be pulled off from the capsule base by hand. The filter element is preferably tear-resistant. The sealing film or foil is preferably a plastic film which has at least one barrier layer, for example a metal layer, in particular an aluminum layer. The plastic film preferably has a “peel-off layer” on its side which faces the capsule, in order to be able to remove the plastic film from the capsule base with comparative ease.

The outlet opening is preferably provided in such a size that it can accommodate a perforation means, which may be present, in a contact-free manner. The outlet opening is particularly preferably provided in such a size that it exhibits no appreciable pressure loss when the ready beverage flows out, in particular that there is no appreciable swirling of the ready beverage, which could lead to air entering the beverage and therefore to the formation of foam.

The portion capsule preferably has a liquid distributor device which deflects the inflowing liquid and distributes it over the cross section of the portion capsule.

The filter element is preferably elastic and arranged and/or attached, at least in its edge region, in the region of the capsule base. When the capsule base is pierced by an external perforation means, the filter element can, when contact is made with the perforation means, yield or be stretched, on account of its elasticity, in such a way that perforation of the filter element is at least minimized. This eliminates the risk of the filter element being completely perforated by the perforation means and beverage substance being washed out of the portion capsule without being filtered. A fixed spacing between the filter element and the capsule base, as is known from the prior art, is not necessary since this distance is automatically created by the perforation means. Furthermore, a collection tank for the beverage liquid which passes through the filter element is produced beneath the filter element in this way.

At least one layer of the filter element is preferably stretched, tapped and/or pierced by the perforation means.

According to a further embodiment of the present invention, provision is made for the filter element to completely or only partially cover the capsule base. In particular, it is sufficient for the filter element to be arranged solely in the region of the perforation or in the region of an outlet opening in the capsule base.

According to a further embodiment of the present invention, provision is made for the filter element to be attached to the capsule base, with the filter element preferably being attached to the capsule base in a cohesive manner, in particular by sealing. This advantageously prevents the filter element from slipping. This attachment is preferably carried out by means of ultrasonic welding.

According to a further embodiment of the present invention, provision is made for the filter element to be attached to the capsule base in an edge region of the capsule base. This advantageously prevents the filter element from slipping down and increases the sealing effect between the capsule body and the filter element, but with it further being made possible to lift off the filter element in its central region at the same time. In this case, the filter element is preferably elastic.

According to a further embodiment of the present invention, provision is made for the capsule base to have a protrusion in a direction opposing the filling side. The protrusion advantageously serves to accommodate the perforation means, so that when the perforation means punctures the capsule base, the capsule base is perforated in the region of the protrusion but the perforation means then remains in the cavity in the protrusion. In this case, at least one layer of the filter element is preferably tapped and/or pierced. The protrusion preferably at least partially holds the felt element.

According to a further embodiment of the present invention, provision is made for the filter element to lift off from the capsule base only in a central region and to continue to rest on the capsule base or remain attached to the capsule base in the edge region of the capsule base. This advantageously prevents the filter element from slipping and increases the sealing effect between the capsule body and the filter element, but with it further being made possible to lift off the filter element in its central region at the same time. In this case, the filter element is preferably elastic.

According to a further embodiment, the capsule base permanently has an outlet opening which is preferably sealed off by a film or foil, with the film or foil particularly preferably having a pull-off tab for pulling off the film or foil by hand. Perforation of the capsule base by means of an external perforation means is advantageously unnecessary in this case. Before the portion capsule is inserted into the brewing chamber, the film or foil is simply pulled off the capsule base by means of the pull-off tab and the brewing process can be started. Combining a prefabricated and therefore comparatively large outlet opening with a filter element comprising one or more non-woven layers and/or one layer with a felt structure, in particular needle felt, has the advantage that the beverage liquid does not flow out of the outlet opening under high pressure and therefore the formation of foam (“crema”), in particular when producing an americano or tea, is prevented.

A further subject matter of the present invention is a method for producing a portion capsule, with the filter element, which comprises two layers, being inserted into the portion capsule and connected to the capsule base, the two layers also being connected to one another substantially at the same time.

The statements made in relation to one subject matter of the present invention apply to the other subjects in equal measure, and vice versa.

The connection of the filter element to the base and the connection between the layers are preferably made by welding, in particular ultrasonic welding. During the connection of the bottom layer, which is in contact with the base, to the base, the two layers are also joined to one another substantially at the same time, preferably by the same sonotrode.

A further subject matter of the present invention is a method for producing a beverage using the portion capsule according to the invention, wherein the portion capsule is provided in a first method step, the capsule base is perforated by means of an external perforation means in a second method step, and at least one layer of the filter element is at least partially spaced apart from the capsule base and/or the distance between the layers is increased in a third method step.

The statements made in relation to one subject matter of the present invention apply to the other subjects in equal measure, and vice versa.

According to a further embodiment of the present invention, provision is made for the filter element to be at least partially stretched when the central region is spaced apart from the capsule base. This makes it possible to attach the edge region of the filter element to the capsule base in a cohesive manner, it nevertheless being possible for the filter element to be lifted off from the capsule base in the central region. The advantages of a maximum sealing effect are combined with the advantages of the rising filter element as a result. As an alternative or in addition, the distance between the two layers is increased locally, in particular in the central region.

A further subject matter of the present invention is the use of a portion capsule for producing a beverage, preferably for producing a coffee, cocoa, tea and/or milk beverage.

The statements made in relation to one subject matter of the present invention apply to the other subjects in equal measure, and vice versa.

Exemplary embodiments of the invention are illustrated in the figures and explained in greater detail in the following description. The figures are described merely by way of example and do not restrict the general concept of the invention. The description applies to all the subjects of the present invention in equal measure.

FIG. 1 shows a longitudinal section through a portion capsule according to a first embodiment of the present invention, which portion capsule is designed for the purpose of preparing an espresso.

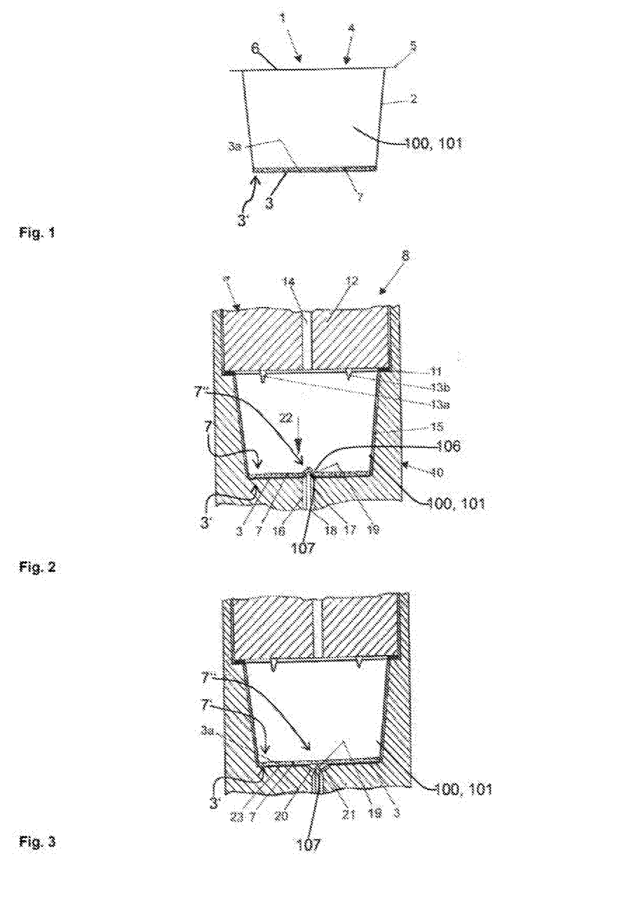

FIG. 2 shows a longitudinal section through a portion capsule, which is situated in a closed brewing chamber, according to the first embodiment of the present invention.

FIG. 3 shows a longitudinal section through a portion capsule, which is situated in a closed brewing chamber, according to a second exemplary embodiment of the present invention.

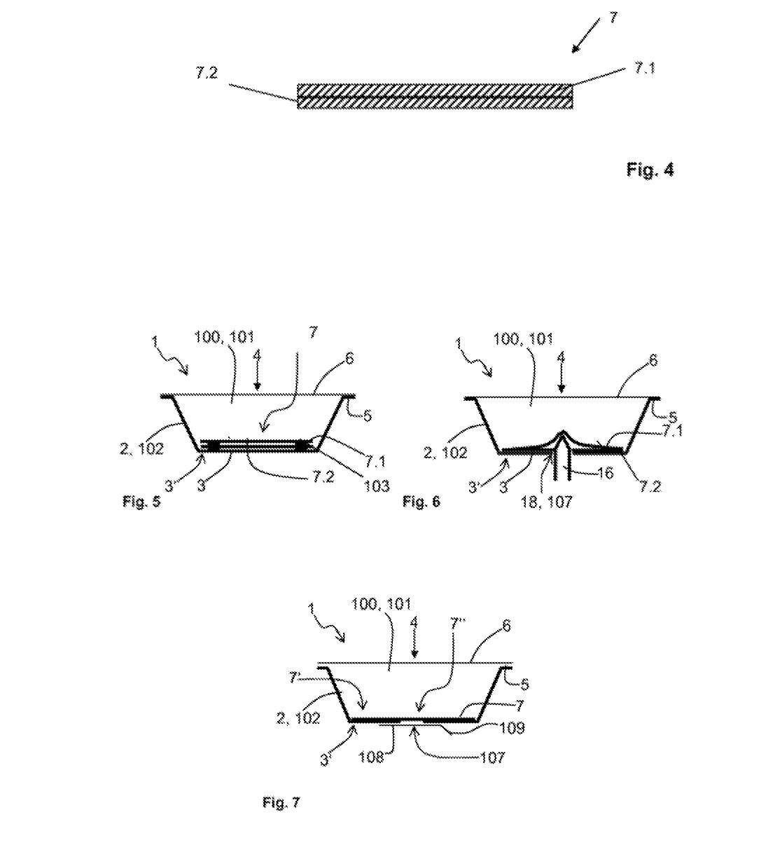

FIG. 4 shows a first embodiment of the filter element.

FIG. 5 schematically shows the production of the portion capsule.

FIG. 6 schematically shows the tapping of a portion capsule.

FIG. 7 shows a portion capsule with a closed base opening.

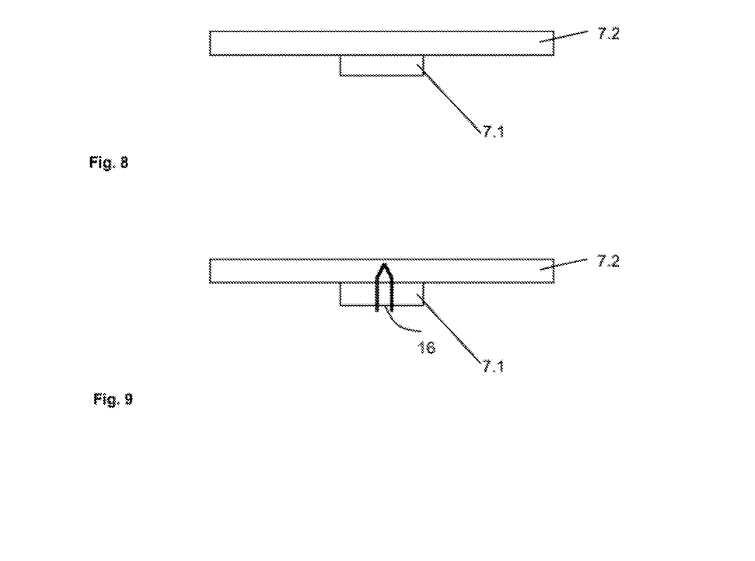

FIG. 8 shows a further embodiment of the filter.

FIG. 9 shows the perforation of the filter according to FIG. 8.

In the various figures, identical parts are always provided with the same reference symbols and therefore also will be generally cited or mentioned only once in each case.

FIG. 1 illustrates a first embodiment of the portion capsule 1 according to the invention. The portion capsule 1 comprises a capsule body 2 in the form of a truncated cone, having a closed capsule base 3 and having a collar edge 5 which is arranged on the filling side 4 of said capsule body and to which a cover film or foil 6 is welded or adhesively bonded. Therefore, a cavity 100, which is preferably sealed off in an air- and aroma-tight manner, is formed between the capsule base 3 and the cover film or foil 6, said cavity being filled with a pulverulent or granular beverage substance 101. In this case, the beverage substance 101 comprises, for example, coffee, cocoa, tea and/or milk powder (or granules). A filter element 7 is arranged on the inner side 3a of the closed capsule body base 3, that is to say within the cavity 100, which filter element 7 is explained further using the figures which follow. The filter element 7 is situated on the inner side 3a of the capsule base 3 and is firmly, that is to say preferably cohesively, connected to the inner side 3a of the capsule body base 3. Preferably, the filter element 7 is attached in a cohesive manner to the capsule base 3 only in an edge region 3′ of the capsule base 3 in particular along a circular ring. The filter element comprises at least one layer composed of non-woven material, in particular a non-woven material which is produced from fine polyester fibers. The fibers are particularly preferably thermally connected to one another by means of a calender, for example a large number of extruded polyester fibers are arranged one on the other and next to one another and then consolidated (flat-calendered) by means of heated rollers. The non-woven material comprises random fiber and/or fiber-oriented non-woven material.

FIG. 2 illustrates a portion capsule 1 according to the first embodiment, which is illustrated in FIG. 1, of the present invention, with the portion capsule 1 in FIG. 2 being arranged in a closed brewing chamber 8. The brewing chamber 8 consists of a first brewing chamber element 9 and a second brewing chamber element 10, with the first brewing chamber element 9 being provided for the purpose of inserting the portion capsule 1 such that it can move in relation to the second brewing chamber element 10, or vice versa. A seal 11 is arranged between the two brewing chamber elements 9, 10. The first brewing chamber element 9 substantially consists of a closing piston 12 with puncturing elements 13a, 13b for opening the cover film or foil 6 of the portion capsule 1, a preparation liquid supply means 14 and the seal 11. The second brewing chamber element 10 substantially consists of a brewing chamber bell 15 which partially surrounds the portion capsule 1 and has an opening mandrel 16 which is arranged on the base of the brewing chamber bell 15 and is provided with discharge grooves 17, and a beverage discharge means 18. For the purpose of accommodating the portion capsule 1, the brewing chamber 8 is in an open state (not illustrated), in which the first and the second brewing chamber element 9, 10 are spaced apart from one another in order to ensure supply of the portion capsule 1, and in the illustrated closed state, in which a preparation process for producing a beverage using the portion capsule 1 can be carried out. In the closed state, the brewing chamber 8 is sealed off in a pressure-tight manner. When the brewing chamber 8 is moved from the open state to the depicted closed state, the cover film or foil 6 is pierced by the puncturing elements 13a, 13b, so that preparation liquid, in particular hot brewing water, passes through the preparation liquid supply means 14 under pressure and into the cavity 100 in the portion capsule 1. Furthermore, when the brewing chamber 8 is closed, the capsule base 3 is perforated by the perforation means, which is in the form of an opening mandrel 16, and therefore an outlet opening 107 is produced in the portion capsule 1, it being possible for the produced beverage liquid to leave the portion capsule 1 in the direction of the beverage discharge means 18 through said outlet opening. In order to assist delivery of the beverage liquid, the opening mandrel 16 is preferably provided with the discharge grooves 17 on its casing surface. In the illustration, the base 3 of the portion capsule 1, which is located in the brewing chamber 9, 10, is pierced by the opening mandrel 16 of the second brewing chamber element, but the filter element 7, which is situated above the puncturing point, is slightly raised by the puncturing spike 19 of the opening mandrel 16 but not pierced. This is achieved, in particular, by the central region 7″ not being cohesively connected to the capsule base 3 but the filter element 7 being cohesively connected to the capsule base 3 only in the edge region 3′ of the capsule base 3, so that it is raised only from the capsule base 3 as a result of the mechanical contact with the spike of the opening mandrel 16 and therefore remains unperforated (that is to say is not perforated by the opening mandrel 16). The capsule base 3 and the filter element 7 remain in contact with one another and, in particular, cohesively connected to one another in the edge region 3′ of the capsule base 3 and in the edge region 7′ of the filter element 7, and therefore no beverage substance 101 enters the beverage discharge means 18 around the filter element 7. However, it is also possible for the opening mandrel 16 to tap and/or pierce at least one layer of the filter element 7.

FIG. 3 illustrates a portion capsule 1 according to a second embodiment of the present invention, with the second embodiment substantially resembling the first embodiment, which is illustrated in FIG. 2, and likewise illustrating the portion capsule 1 in a closed brewing chamber 8. However, in contrast to the first embodiment, the portion capsule base 3 has, in the puncturing region of the opening mandrel 16, a protrusion 21 which is directed toward a recess 20 in the brewing chamber base 3a (the protrusion 21 is therefore directed in a direction which opposes the filling side 4) and which the opening mandrel 16 enters, without piercing the filter element 7 in the process. Therefore, it is, in particular, not necessary to lift off the filter element 7 from the capsule base 3. In order to produce the beverage, the brewing chamber 8 is closed again after the portion capsule 1 is inserted into the brewing chamber 8. During the closing process, the cover film or foil 6 of the portion capsule 1 is perforated by means of the puncturing means 13a, 13b and, after the first and the second brewing chamber element 9, 10 are brought together and sealed (by means of the seal 11), brewing water is made available via the liquid inlet 6. The opening mandrel 16 likewise makes an opening in the base 3 of the portion capsule 1 during the closing process of the brewing chamber. The thickness and the tear strength of the filter element 7, which is situated above the puncturing point, are matched to the penetration depth of the puncturing spike 19 of the opening mandrel 16, and therefore the filter element 7 is not pierced. As an alternative, the filter element 7 is situated above the protrusion 21 of the capsule base 3, which protrusion is situated in the recess in the brewing bell base 23, and the opening mandrel 16 enters only the protrusion 21 of the capsule base 3 and does not reach the filter element 7. The liquid, for example hot water when coffee is being produced, then flows into the capsule 1. In the capsule, this liquid flows through the beverage base 101 and extracts and/or dissolves the substances, which are required to produce the beverage, from the beverage base 101. The flow of the liquid in the beverage base 101 is illustrated by reference symbol 22. The resulting beverage then flows through the filter element 7 which is arranged between the beverage base 101 and the on the capsule base 3, this preventing constituents of the beverage base 101 entering the resulting beverage in particulate form and further entering a collection vessel, for example a cup or pot, via the opening made in the capsule base 3 by the opening mandrel 16 and via the discharge grooves 17 in the opening mandrel 16.

FIG. 4 shows a first embodiment of the filter element 7. According to the invention, said filter element has a first layer 7.1 and a second layer 7.2, which layers are each produced from a non-woven, that is to say a non-woven material, in the present case. The two layers 7.1, 7.2 are connected to one another in a cohesive manner, in particular by welding, preferably by ultrasonic welding, here. The two layers are provided as circular disks here. The connection is preferably made along a circular ring which particularly preferably extends in a concentric manner around the rotation axis of the portion capsule. The two layers are preferably identical, but may also differ in respect of material, thickness and/or diameter.

As can be seen in FIG. 5 in particular, the two layers are initially preferably inserted into the portion capsule as separate parts and the bottom layer 7.2 is then connected to the base 3 of the portion capsule connected filter element 7 at the base 3 of the portion capsule by welding, in particular ultrasonic welding. At the same time, the two layers 7.1 and 7.2 are connected to one another in the process. The connection both between the filter element 7 and the capsule base 3 and also between the two layers 7.1, 7.2 of the filter element is preferably made along a circular ring. A sonotrode preferably pushes the two layers together and, in the process, against the base of the portion capsule. In this case, the two layers are welded to one another and the bottom layer is connected to the base of the portion capsule at least substantially at the same time.

FIG. 6 shows the tapping of the portion capsule by means of an opening mandrel 16 which initially pierces the capsule base 3 and as a result provides a discharge means for the beverage which is to be prepared. As can be seen in the illustration according to FIG. 6, the opening mandrel preferably pierces at least the bottom layer of the filter element and at least taps the top layer 7.2. In particular, the distance between the two layers is increased locally, in the central region of the filter element in this case.

FIG. 7 shows a further embodiment of the portion capsule according to the invention. In the present case, a permanent opening is provided in the capsule base, said permanent opening being closed by a pull-off tab 109 in this case. This pull-off tab can be pierced by the opening mandrel or can be manually removed, for example by being pulled off, before the beverage is prepared.

FIG. 8 shows a further embodiment of the filter 7, which filter again is provided with two layers, wherein the filter element has a first layer 7.2, which is composed of a non-woven material, and a second layer 7.1, which is composed of a felt material, in the present case. The two layers are preferably cohesively connected to one another, and a surface against which beverage flows or the diameter of the layer 7.1 is very particularly preferably small in comparison to the layer 7.2. The thickness of the two layers can be the same or different. FIG. 9 schematically shows the tapping of a portion capsule which contains the filter element 7. Said figure clearly shows that the layer 7.1 is pierced and the layer 7.2 is only tapped. This ensures that no granules can, for example, enter a beverage which is to be prepared.

### LIST OF REFERENCE SYMBOLS

1 Portion capsule
2 Capsule body
3 Capsule base:
3a Inner side of the capsule base
3′ Edge region of the capsule base
4 Filling side
5 Collar edge
6 Cover film or foil
7 Filter element
7′ Edge region of the filter element
7″ Central region of the filter element
7.1 Felt structure, needle felt structure
7.2 Support structure
7.3 Felt structure, needle felt structure
8 Brewing chamber
9 First brewing chamber element
10 Second brewing chamber element
11 Seal
12 Closing piston
13a Puncturing element
13b Puncturing element
14 Preparation liquid supply means
15 Brewing bell
16 Opening mandrel
17 Discharge grooves
18 Discharge means
19 Puncturing spike
20 Recess
21 Protrusion
22 Preparation liquid flow
23 Brewing bell base
100 Cavity
101 Beverage base
102 Side wall region
103 Attachment of the filter 7, welding
103′ Corrugated or folded region
104 Predetermined breaking point
105 Lines of weakness
106 Central point
107 Outlet opening
108 Film or foil
109 Pull-off tab

1. A portion capsule (1) for producing a beverage, having a capsule body (2) with a capsule base (3) and a filling side (4), with a cavity (100) for accommodating a pulverulent or liquid beverage base (101) being formed between the capsule base (3) and the filling side (4), and with a filter element (7) being arranged between the beverage base (101) and the capsule base (3), with the filter element (7) being provided from a non-woven material which is arranged in the region of the capsule base (3), characterized in that the filter element is provided from two layers (7.1, 7.2).

2. The portion capsule (1) as claimed in claim 1, characterized in that at least one layer (7.1), preferably both layers (7.1, 7.2), is/are provided from a non-woven.

3. The portion capsule (1) as claimed in claim 2, characterized in that the two layers (7.1, 7.2) are connected to one another by a cohesive connection, in particular by a sealing effect.

4. The portion capsule (1) as claimed in claim 3, characterized in that the cohesive connection is provided locally, in particular as a circular ring.

5. The portion capsule (1) as claimed in claim 1, 3 or 4, characterized in that the filter element (7) is provided from a non-woven layer (7.1) and a filter layer (7.2).

6. The portion capsule (1) as claimed in claim 5, characterized in that the felt layer (7.2) has a smaller surface against which beverage flows than the non-woven layer (7.1).

7. The portion capsule (1) as claimed in one of claims 1-6, characterized in that the non-woven comprises a non-woven material which is produced from fine polyester fibers, and/or in that the non-woven has a mass per unit area of between 50 and 150 grams per square meter, preferably of between 80 and 120 grams per square meter and particularly preferably 100 grams per square meter, and/or in that the non-woven has a thickness of between 0.2 and 0.8 millimeters, preferably of between 0.25 and 0.39 millimeters and particularly preferably of substantially 0.32 millimeters, and/or in that the non-woven has an air permeability of between 1000 and 3000 l/(m²s), preferably of between 1500 and 2500 (l/m²s) and particularly preferably substantially of 2000 l/(m²s) at a pressure of 100 pascal.

8. The portion capsule (1) as claimed in one of the preceding claims, characterized in that the filter element (7) is sealed, in particular ultrasonically sealed and preferably stretched, at the base of the capsule.

9. The portion capsule (1) as claimed in one of the preceding claims, characterized in that the filter element (7) completely or only partially covers the capsule base (3).

10. The portion capsule (1) as claimed in one of the preceding claims, characterized in that the capsule base (3) has a protrusion (21) in a direction (103) opposing the filling side (4).

11. The portion capsule (1) as claimed in one of the preceding claims, characterized in that the filter element (7) is formed in such a way that, when the capsule base (3) is perforated by an external perforation means (16), the filter element (7) is at least partially lifted off from the capsule base (3), and/or in that the perforation means perforates at least one layer (7.1, 7.2) of the filter (7).

12. The portion capsule (1) as claimed in claim 11, characterized in that the filter element (7) lifts off from the capsule base (3) only in a central region (7″) and continues to rest on the capsule base (3) or remains attached to the capsule base (3) in the edge region (3′) of the capsule base (3).

13. The portion capsule (1) as claimed in claim 11 or 12, characterized in that the perforation means pierces and/or taps both layers (7.1, 7.2).

14. The portion capsule (1) as claimed in one of the preceding claims, characterized in that the filter element (7) is formed in such a way that, when the capsule base (3) is perforated by an external perforation means (16), the filter element (7) lifts off from the capsule base (3) in the central region (7″) of said filter element and/or the distance between the layers (7.1, 7.2) changes.

15. The portion capsule (1) as claimed in one of the preceding claims, characterized in that the capsule base (3) has an outlet opening (107) which is preferably sealed off by a film or foil (108), with the film or foil (108) particularly preferably having a pull-off tab (109) for pulling off the film or foil by hand.

16. A method for producing a portion capsule, characterized in that the filter element (7), which comprises two layers (7.1, 7.2), is inserted into the portion capsule and connected to the capsule base, characterized in that the two layers (7.1, 7.2) are connected to one another substantially at the same time.

17. The method as claimed in claim 16, characterized in that the connection of the filter element to the base and the connection between the layers are preferably made by welding, in particular ultrasonic welding.

18. A method for producing a beverage using a portion capsule (1) as claimed in one of the preceding claims, characterized in that the portion capsule (1) is provided in a first method step, in that the capsule base (3) is perforated by means of an external perforation means (16) in a second method step, and in that, in a third method step, at least one layer (7.1, 7.2) of the filter element (7) is at least partially spaced apart from the capsule base (3) and/or the distance between the layers (7.1, 7.2) is locally increased.

19. The method as claimed in claim 18, characterized in that, in the third method step, the filter element (7) is spaced apart from the capsule base (3) only in a central region (7″) and continues to rest on the capsule base (3) or remains at attached to the capsule base (3) in the edge region (3′) of the capsule base (3).

20. The method as claimed in either of claims 18 and 19, characterized in that the filter element (7) is at least partially stretched when the central region (7″) is spaced apart from the capsule base (3).

21. The use of a portion capsule (1) as claimed in one of claims 1 to 22 for producing a beverage, preferably for producing a coffee, cocoa, tea and/or milk beverage.
